(19) United States
(12) Patent Application Publication
(10) Pub. No.: US 2025/0263264 A1
(43) Pub. Date: Aug. 21, 2025

(54) TAPE ATTACHMENT DEVICE AND TAPE ATTACHMENT METHOD

(71) Applicant: SK On Co., Ltd., Seoul (KR)

(72) Inventor: Seung Hyeon CHEON, Daejeon (KR)

(21) Appl. No.: 19/052,302

(22) Filed: Feb. 13, 2025

(30) Foreign Application Priority Data
Feb. 19, 2024 (KR) 10-2024-0023311

(51) Int. Cl. B65H 35/00

(52) U.S. Cl. CPC B65H 35/0073; B65H 2404/15212; B65H 2515/34

(57) ABSTRACT

A tape attachment device of the present disclosure includes a roller shaft including a first end portion and a second end portion opposite to the first end portion, and a pressing member including a first cylinder connected to the first end portion, and a second cylinder connected to the second end portion and configured to operate independently of the first cylinder. The roller shaft may be configured to tilt based on movement of the pressing member.

### CROSS-REFERENCE TO RELATED APPLICATION(S)

This patent document claims the priority and benefits of Korean Patent Application No. 10-2024-0023311 filed on Feb. 19, 2024, the disclosure of which is incorporated herein by reference in its entirety.

### TECHNICAL FIELD

The disclosure and implementations disclosed in this patent document generally relate to a tape attachment device and a tape attachment method.

### BACKGROUND

Unlike a primary battery, a secondary battery may be charged and discharged, and may thus be applied to devices within various fields such as a digital camera, a mobile phone, a laptop, a hybrid vehicle, an electric vehicle, and an energy storage system (ESS). The secondary battery may be a lithium-ion battery, a nickel-cadmium battery, a nickel-metal hydride battery, or a nickel-hydrogen battery.

The secondary battery may be manufactured as a flexible pouch-type battery cell or a rigid square or cylindrical can-type battery cell. A plurality of battery cells may be formed as a cell assembly in a stacked form.

The cell assembly may be disposed in a case to form a battery module, and a plurality of battery modules may be disposed in a pack frame to form a battery pack. The battery pack may be used in various structures such as a vehicle or an energy storage system.

### SUMMARY

A tape may be attached to an object (e.g., battery cell or a cell assembly) using a roller pressing the tape. When the tape is attached to an object having a curved shape, the tape may not be in close contact with the object, thereby reducing adhesive strength of the tape. For example, when the tape is attached to a case of a square battery cell in which a curve is formed, or when the tape is attached to a curved sealing portion of a pouch-type battery cell, a contact area between the tape and the case may be reduced due to the curve, thereby reducing the adhesive strength of the tape, and air bubbles may be generated between the tape and the case.

According to an aspect of the present disclosure, a tape attachment device and a tape attachment method, increasing a contact area between a tape and an object to improve adhesive strength of the tape and reduce air bubbles, may be provided. A battery cell manufactured by a tape attachment device of the present disclosure may be widely applied in green technology fields such as to an electric vehicle, a battery charging station, and solar and wind power generation using batteries. In addition, the battery cell manufactured by the tape attachment device of the present disclosure may be used in an eco-friendly electric vehicle, a hybrid vehicle, or the like to prevent a change in climate by suppressing air pollution and greenhouse gas emissions.

In some embodiments of the present disclosure, a tape attachment device of the present disclosure includes a roller shaft including a first end portion and a second end portion opposite to the first end portion, and a pressing member including a first cylinder connected to the first end portion, and a second cylinder connected to the second end portion and configured to operate independently of the first cylinder. The roller shaft may be configured to tilt based on movement of the pressing member.

According to an embodiment, the tape attachment device may include a first guide member rotatably connecting the first end portion to the first cylinder, and a second guide member rotatably connecting the second end portion to the second cylinder.

According to an embodiment, the first guide member may include a first bearing support coupled to the first cylinder, and a first bearing connected to the first end portion and rotatably coupled to the first bearing support. The second guide member may include a second bearing support coupled to the second cylinder, and a second bearing connected to the second end portion and rotatably coupled to the second bearing support.

In an embodiment, the tape attachment device may further include a memory configured to store external surface curvature data of the battery cell, and a regulator configured to regulate pressure of at least one of the first cylinder or the second cylinder, based on the external surface curvature data.

In an embodiment, the regulator may include a first regulator configured to regulate first pressure of the first cylinder, and a second regulator configured to regulate second pressure of the second cylinder.

In an embodiment, a first stroke distance of the first cylinder may be configured to be changed based on the first pressure, and a second stroke distance of the second cylinder may be configured to be changed based on the second pressure. A slope of the roller shaft may be configured to be changed based on the first stroke distance and the second stroke distance.

In an embodiment, the roller shaft may be configured to provide external force to a tape, and may include an external circumferential surface located between the first end portion and the second end portion.

In an embodiment, the first cylinder and the second cylinder may each include at least one of a pneumatic cylinder, a hydraulic cylinder, or an actuator, respectively.

In an embodiment, the second cylinder may be disposed parallel to the first cylinder.

In an embodiment, the tape attachment device may further include a memory configured to store a limit pressure value, and a pressure sensor disposed on the roller shaft. Output of the pressing member may be configured to be changed based on a pressure value sensed by the pressure sensor and the limit pressure value.

In some embodiments of the present disclosure, a tape attachment method of the present disclosure may include a pressing operation of pressing a tape using a roller shaft, and a pressure regulating operation of regulating at least one of pressure of a first cylinder connected to a first end portion of the roller shaft, or pressure of a second cylinder connected to a second end portion of the roller shaft. The roller shaft may be configured to tilt based on the pressure regulating operation.

### BRIEF DESCRIPTION OF DRAWINGS

Certain aspects, features, and advantages of the present disclosure may be illustrated by the following detailed description with reference to the accompanying drawings.

FIG. 1 is a perspective view of a battery cell according to an embodiment.

FIG. 2 is an exploded perspective view of a battery cell according to an embodiment.

FIG. 3 is a schematic diagram illustrating an operation of a tape attachment device according to an embodiment.

FIGS. 4A and 4B are schematic diagrams of a tape attachment device according to an embodiment.

FIG. 5 is a flow chart of a tape attachment method according to an embodiment.

### DETAILED DESCRIPTION

Hereinafter, the disclosure of this patent document will be described in detail with reference to the attached drawings. However, this is merely illustrative and the disclosure of this patent document is not limited to the specific embodiments described by way of example.

Terms or words used in the specification and claims described below may not be to be construed as limited to their ordinary or dictionary meanings. The inventor will interpret the meaning and concept consistent with the technical idea of the disclosure of this patent document based on the principle that the concept of the term is appropriately defined in order to explain the disclosure of this patent document in the best manner.

Accordingly, the embodiments described in this specification and the configurations illustrated in the drawings may be only the most preferred embodiments of the disclosure of this patent document, and do not represent the entire technical idea of the disclosure of this patent document, and it will be appreciated that there are various equivalents and variations may be substituted therefor at the time of filing the disclosure of this patent document.

Detailed descriptions of well-known functions and configurations that may obscure the gist of the disclosure of this patent document may be omitted. In the attached drawings, some components may be exaggerated, omitted, or schematically illustrated, and a size of each of the components does not entirely reflect an actual size thereof.

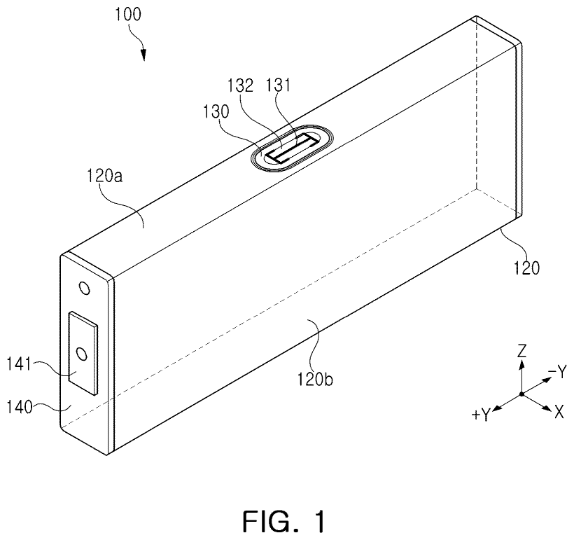

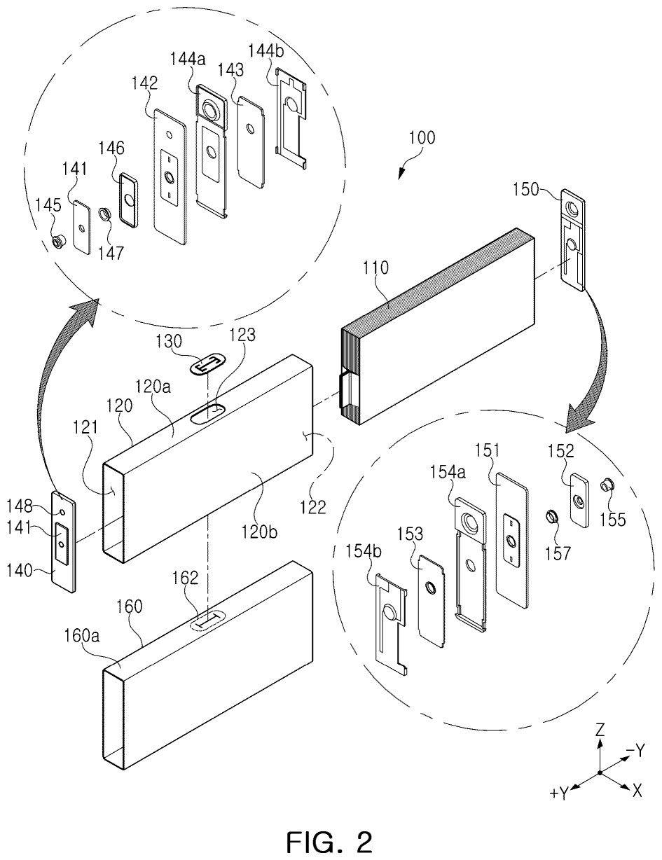

FIG. 1 is a perspective view of a battery cell according to an embodiment. FIG. 2 is an exploded perspective view of a battery cell according to an embodiment.

Referring to FIG. 1 and/or FIG. 2, a battery cell 100 may include an electrode assembly 110, a case 120, a venting portion 130, a cap assembly (140 and 150), and/or a tape 160. The battery cell 100 may be a secondary battery. For example, the battery cell 100 may be a lithium ion battery, but is not limited thereto. For example, the battery cell 100 may be a nickel-cadmium battery, a nickel-metal hydride battery, or a nickel-hydrogen battery, capable of being charged and discharged.

The electrode assembly 110 may include at least one positive electrode plate, at least one negative electrode plate, and at least one separator. Those skilled in the art will appreciate that the electrode assembly 110 may be manufactured using variety of methods. In example embodiments, the electrode assembly may be formed by repeatedly arranging the positive electrode, the negative electrode, and the separator. In some embodiments, the electrode assembly may be a winding type, a stacking type, a Z-folding type, or a stack-folding type.

The case 120 may form at least a portion of an exterior of the battery cell 100, and may accommodate the electrode assembly 110. For example, the case 120 may provide a space in which the electrode assembly 110 and an electrolyte are accommodated. In an embodiment, the case 120 may include aluminum. The case 120 may be referred to as a can or a housing. The case 120 may have a rectangular parallelepiped shape in which at least a portion thereof opens. For example, the case 120 may include a first side surface 120a and a second side surface 120b having a width, greater than a width of the first side surface 120a. The first side surface 120a may be referred to as a narrow surface, and the second side surface 120b may be referred to as a wide surface.

According to an embodiment, the case 120 may include a first opening 121 formed at one side (+Y-direction) of a length direction (Y-axis direction) of the battery cell 100, a second opening 122 formed on the other side (−Y-direction) of the length direction, and a through-hole 123 formed in a height direction (Z-axis direction) of the battery cell 100. The first opening 121, the second opening 122, and the through-hole 123 may be an empty space connected in an internal space of the case 120.

The cap assembly (140 and 150) may be respectively coupled to both sides in the length direction (e.g., Y-axis direction) of the case 120. For example, the cap assembly (140 and 150) may accommodate the electrode assembly 110 and the electrolyte, together with the case 120. The cap assembly (140 and 150) may include a first cap assembly 140 coupled to an end portion of the case 120 in the second direction (+Y direction), and a second cap assembly 150 coupled to an end portion of the case 120 in the third direction (−Y direction) opposite to the second direction (+Y direction). The first cap assembly 140 may seal the first opening 121 of the case 120. The second cap assembly 150 may seal the second opening 122 of the case 120.

The cap assembly (140 and 150) may include a plurality of components.

In an embodiment, the cap assembly (140 and 150) may include a cap plate (142 and 151) coupled to the case 120 to seal the case 120. For example, the cap plate (142 and 151) may be formed of aluminum or a material including aluminum. The cap plate (142 and 151) may be laser welded to the case 120 along an edge portion. When the cap plate (142 and 151) is coupled to the case 120, since an internal space of the case 120 may be sealed, at least one of the cap plates 142 and 151 may include an electrolyte injection port 148 for injecting an electrolyte into the internal space of the case 120. The electrolyte injection port 148 may be sealed with a stopper or the like after the electrolyte is injected.

The cap assembly (140 and 150) may include a terminal plate (141 and 152). The terminal plate (141 and 152) may be coupled to one surface of the cap plate (142 and 151). The one surface of the cap plate (142 and 151) may be a surface, opposite to a surface facing the internal space of the case 120. When the battery cell 100 is configured to form a module or a pack, the battery cell 100 may be electrically connected to a battery cell 100 disposed adjacently thereto, through the terminal plate (141 and 152).

The terminal plate (141 and 152) may have positive polarity or negative polarity. For example, based on the drawings, a first terminal plate 141 disposed in the second direction (+Y direction) of the case 120 may have negative polarity, and a second terminal plate 152 disposed in the third direction (−Y direction) of the case 120 may have positive polarity. For example, the terminal plates 141 and 152 may be electrically connected to the electrode assembly 110 through electrode tabs, respectively.

In an embodiment, an insulating plate (outer insulating plate) 146 may be disposed between a terminal plate having negative polarity (e.g., first terminal plate 141) and a first cap plate 142.

A current collector plate (143 and 153) may be disposed on the other surface of the cap plate (142 and 151). The current collector plate (143 and 153) may be connected to an electrode tab portion of a first electrode plate 111 or an electrode tab portion of a second electrode plate 112 in the electrode assembly 110, respectively, to have positive polarity or negative polarity. An insulating plate (inner insulating plate) (144a, 144b, 154a, and 154b) may be disposed between the cap plate (142 and 151) and the current collector plate (143 and 153) and between the current collector plate (143 and 153) and the internal space of the case 120, respectively.

According to an embodiment of the present disclosure, the cap assembly (140 and 150) may include a rivet terminal (145 and 155) passing in a thickness direction from the terminal plate (141 and 152) and extending to the current collector plate (143 and 153). To this end, the cap plate (142 and 151), the terminal plate (141 and 152), the current collector plate (143 and 153), and a portion of the insulating plates (144a and 154a) may include a hole into which the rivet terminal (145 and 155) is inserted, and a gasket (147 and 157) may be fitted between the hole and the rivet terminal (145 and 155).

Components of the cap assembly (140 and 150), described above, are only illustrative, so some of the components of the cap assembly (140 and 150) may be omitted or other configurations not described may be added.

The venting portion 130 may provide a path releasing gas generated from the internal space of the case 120 to an external space of the case 120. For example, the venting portion 130 may include a notch portion 131 configured to be ruptured at a specified pressure or higher, and a base 132 coupled to the case 120.

According to an embodiment, the venting portion 130 may be located on the first side surface 120a of the case 120 in which a relatively large stress value appears, among remaining surfaces of the case 120 excluding a portion to which the cap assembly (140 and 150) is coupled. The venting portion 130 may be located between the first cap assembly 140 and the second cap assembly 150. According to an embodiment, at least a portion of the venting portion 130 may be disposed in the through-hole 123 formed in the first side surface 120a.

In a battery cell 100 including a plurality of cap assemblies (140 and 150) located at both sides of the length direction of the case 120, as in an embodiment of the present disclosure, a space available for one cap assembly (140 and 150) may be reduced. Since the venting portion 130 may be formed on the case 120, a degree of design freedom of the venting portion 130 may be improved, and discharging of gas in the case 120 may be improved. In the present document, the venting portion 130 formed on the first side surface 120a of the case 120 is illustrated, but is illustrative. For example, in another embodiment, the venting portion 130 may be located on the cap assembly (140 and 150).

According to an embodiment, the base 132 may be welded and coupled to the case 120 along an edge portion. The base 132 may be a plate including aluminum.

In an embodiment, the notch portion 131 may be a recess, a groove, and/or a hole, formed in the base 132. The notch portion 131 may be a portion of the venting portion 130 that may be broken earlier than other portions, when pressure in the case 120 is higher than predetermined pressure. A thickness of at least a portion of the notch portion 131 may be thinner than a thickness of the base 132.

According to the present disclosure, since at least a portion of gas generated in the case 120 may be discharged through an empty space of the venting portion 130 formed by rupture of the notch portion 131, a direction of discharging gas may be controlled from the perspective of the battery cell 100.

The tape 160 may be used for insulation of the case 120 of the battery cell 100. For example, the tape 160 may include an insulating material. The tape 160 may be referred to as a protective film, a protective member, a protective tape, an insulating film, an insulating member, and/or an insulating tape. According to an embodiment, the tape 160 may include an adhesive material for coupling to the case 120 and the venting portion 130.

The tape 160 may cover at least a portion of the case 120. Although the tape 160 is illustrated in the present document as entirely covering the case 120, a position in which the tape 160 covers the case 120 may be changed depending on a design. For example, in an embodiment, the tape 160 may cover at least a portion of the venting portion 130 and at least a portion of the first side surface 120a of the case 120. In an embodiment, at least a portion of the tape 160 may be folded to overlap.

In an embodiment, a cover region 162 of the tape 160 may cover the venting portion 130. After the notch portion 131 of the venting portion 130 is broken, at least a portion of the tape 160 (e.g., cover region 162) may come into contact with at least a portion of venting gas passed through the notch portion 131 of the venting portion 130. A path of gas generated from the venting portion 130 may be changed due to the cover region 162.

In the present document, a structure in which the battery cell 100 is a square battery cell in which both directions are opened is illustrated, but is illustrative. For example, in an embodiment not illustrated, the battery cell 100 may be a square battery cell or a pouch-type battery cell in which a single direction is opened.

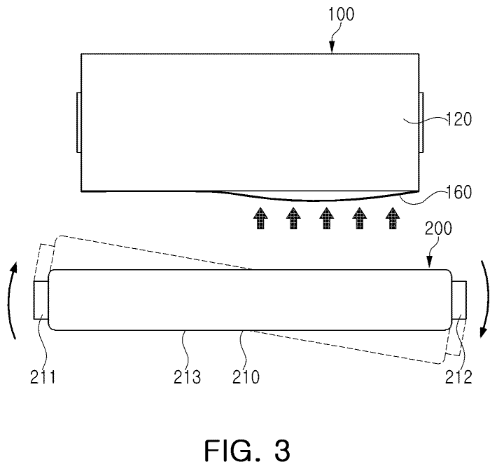

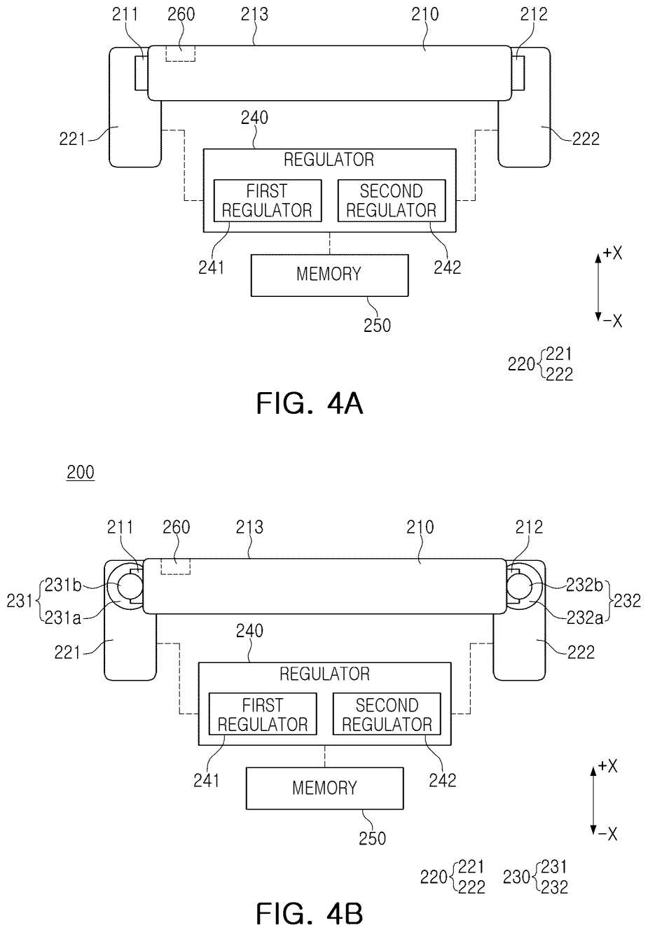

FIG. 3 is a schematic diagram illustrating an operation of a tape attachment device according to an embodiment. FIGS. 4A and 4B are schematic diagrams of a tape attachment device according to an embodiment.

Referring to FIGS. 3, 4A, and/or 4B, a tape attachment device 200 may include a roller shaft 210 and a pressing member 220. The tape attachment device 200 may apply external force to an object to adhere a tape to a surface. For example, the tape attachment device 200 may attach a tape 160 of a battery cell 100 to a case 120. Descriptions of the battery cell 100, the case 120, and the tape 160 of FIG. 1 and/or FIG. 2 may be applied to the battery cell 100, the case 120, and the tape 160 of FIG. 3.

In the present document, only a structure in which the tape attachment device 200 attaches the tape 160 to a surface of the case 120 of a square battery cell (e.g., battery cell 100 of FIG. 1) in which both directions are opened is illustrated, but usage of the tape attachment device 200 is not limited thereto. For example, the tape attachment device 200 may be used to attach an insulating tape attached to a surface of a square battery cell 100 in which a single direction is opened, a tape for fixing a curved sealing portion of a pouch-type battery cell, or a tape used for connecting a plurality of battery cells.

The roller shaft 210 may be in contact with an insulating tape (e.g., tape 160), and may closely contact the tape with an object (e.g., case 120). When the surface of the case 120 is curved, a contact area between the roller shaft 210 and the tape 160 may be reduced, thereby reducing an adhesive force of the tape 160 to the case 120.

The roller shaft 210 may include a first end portion 211 and a second end portion 212. The roller shaft 210 may include an external circumferential surface 213 extending from the first end portion 211 to the second end portion 212. The external circumferential surface 213 may be in contact with the tape 160, to attach and adhere the tape 160 to the case 120. As the tape 160 and the roller shaft 210 are in close contact with each other, air bubbles located between the tape 160 and the case 120 may be reduced.

The roller shaft 210 may be tilted in accordance with a shape of the case 120. For example, the roller shaft 210 may be tilted by force or pressure provided from the pressing member 220. The first end portion 211 and the second end portion 212 of the roller shaft 210 may be connected to the pressing member 220, respectively.

The pressing member 220 may provide pressure or force to both end portions 211 and 212 of the roller shaft 210. For example, the pressing member 220 may include a first cylinder 221 configured to move the first end portion 211, and a second cylinder 222 configured to move the second end portion 212. A position of the first end portion 211 may be changed based on movement of the first cylinder 221. A position of the second end portion 212 may be changed based on movement of the second cylinder 222. The positions of the first end portion 211 and/or the second end portion 212 may be changed to change a slope of the roller shaft 210. According to an embodiment (e.g., FIG. 4A), the first cylinder 221 may be connected to the first end portion 211. The second cylinder 222 may be connected to the second end portion 212. The roller shaft 210 may be tilted by a space located between components of the first cylinder 221 and/or a space located between components of the second cylinder 222. For example, a position of the roller shaft 210 may be changed by clearance formed relative to the roller shaft 210.

The second cylinder 222 may be disposed substantially parallel to the first cylinder 221. For example, the first cylinder 221 and the second cylinder 222 may move in the first direction (e.g., X-axis direction), respectively.

The first cylinder 221 and the second cylinder 222 may be an air cylinder (e.g., pneumatic cylinder). However, this is illustrative, and the first cylinder 221 and the second cylinder 222 may be replaced with other components that may implement linear motion or piston motion, such as a hydraulic cylinder or an actuator.

According to an embodiment (e.g., FIG. 4B), the tape attachment device 200 may include a guide member 230. The guide member 230 may rotatably connect the roller shaft 210 to the pressing member 220. For example, the guide member 230 may include a first guide member 231 rotatably connecting the first end portion 211 to the first cylinder 221, and a second guide member 232 rotatably connecting the second end portion 212 to the second cylinder 222. The first guide member 231 may include a first bearing support 231a coupled to the first cylinder 221, and a first bearing 231b coupled to the first end portion 211. The first bearing 231b may be rotatably coupled to the first bearing support 231a. For example, at least a portion of the first bearing 231b may rotate while being accommodated in the first bearing support 231a. The second guide member 232 may include a second bearing support 232a coupled to the second cylinder 222, and a second bearing 232b coupled to the second end portion 212. The second bearing 232b may be rotatably coupled to the second bearing support 232a. For example, at least a portion of the second bearing 232b may rotate while being accommodated in the second bearing support 232a.

The tape attachment device 200 may include at least one regulator 240 configured to control driving of the pressing member 220. The regulator 240 may regulate pressure of the first cylinder 221 and pressure of the second cylinder 222. The first cylinder 221 and the second cylinder 222 may operate independently, respectively. For example, the first cylinder 221 and the second cylinder 222 may be respectively connected to separate regulators 240. According to an embodiment, the regulator 240 may include a first regulator 241 configured to regulate first pressure of the first cylinder 221, and a second regulator 242 configured to regulate second pressure of the second cylinder 222. A first stroke distance of the first cylinder 221 may be changed based on the first pressure regulated by the first regulator 241, and a second stroke distance of the second cylinder 222 may be changed based on the second pressure regulated by the second regulator 242. A slope of the roller shaft may be changed based on the first stroke distance and the second stroke distance. The first stroke distance and the second stroke distance may refer to distances that the first cylinder 221 and the second cylinder 222 move, relative to a reference position (e.g., position to which no pressure is applied), respectively.

The tape attachment device 200 may include a memory 250.

The memory 250 may store external surface curvature data of the battery cell 100. In an embodiment, the external surface curvature data may be data reflecting surface curvature of the case 120 of the square battery cell 100. The external surface curvature data may be sensed using a distance sensor or the like. In another embodiment, the external surface curvature data may be data reflecting surface curvature of a curved sealing portion of a pouch-type battery cell. In yet another embodiment, the external surface curvature data may be data reflecting surface curvature of a cell assembly including a plurality of battery cells. The external surface curvature data may be measured using a sensor during a manufacturing process of the battery cell 100 and/or the cell assembly. The regulator 240 may regulate pressure of the pressing member 220 in response to the external surface curvature data stored in the memory 250. For example, the regulator 240 may regulate at least one of the first pressure of the first cylinder 221 or the second pressure of the second cylinder 222, based on the external surface curvature data. The pressure of the first cylinder 221 and/or the pressure of the second cylinder 222 may be regulated by the regulator 240, the slope of the roller shaft 210 may be changed.

According to an embodiment, the memory 250 may store a limit pressure value for preventing or reducing damage to the case 120 of the battery cell 100.

According to an embodiment, the tape attachment device 200 may include a pressure sensor 260. For example, the tape attachment device 200 may include a pressure sensor 260 disposed on the roller shaft 210. The pressure sensor 260 may detect the pressure applied to the first end portion 211 and/or the second end portion 212 of the roller shaft 210. Output of the pressing member 220 may be controlled based on a pressure value sensed by the pressure sensor 260 and the limit pressure value stored in the memory 250. For example, the regulator 240 or a processor (not illustrated) may stop or reduce the output of the pressing member 220, when a sensed pressure value exceeds the limit pressure value stored in the memory 250. The output of the pressing member 220 may be limited by the pressure sensor 260, to reduce or prevent damage to the battery cell 100. In an embodiment, the pressure sensor 260 may be a load cell.

According to an embodiment, the first cylinder 221 and the second cylinder 222 may include a servo motor, respectively. For example, the tape attachment device 200 may further include a distance detection sensor (not illustrated) for sensing a surface of the case 120. Driving (e.g., stroke) of the first cylinder 221 and the second cylinder 222 may be changed based on a value sensed by the distance detection sensor.

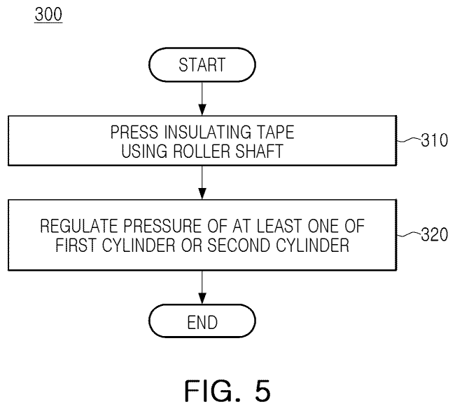

FIG. 5 is a flow chart of a tape attachment method according to an embodiment.

Referring to FIG. 5, together with FIGS. 4A and 4B, a tape attachment method 300 may include a pressing operation 310 and a pressure regulating operation 320. The tape attachment method 300 of FIG. 5 may be performed using the tape attachment device 200 of FIGS. 3, 4A, and/or 4B.

The pressing operation 310 may be an operation of pressing a tape 160 using a roller shaft 210. For example, an external circumferential surface 213 of the roller shaft 210 may provide pressure while contacting the tape 160.

The pressure regulating operation 320 may be an operation of regulating at least one of pressure of a first cylinder 221 connected to a first end portion 211 of the roller shaft 210, or pressure of a second cylinder 222 connected to a second end portion 212 of the roller shaft 210. For example, a first regulator 241 may regulate the pressure of the first cylinder 221, and a second regulator 242 may regulate the pressure of the second cylinder 222.

The roller shaft 210 may be tilted by the pressure regulating operation 320. For example, by the pressure regulating operation 320, a first stroke distance of the first cylinder 221 and/or a second stroke distance of the second cylinder 222 may be changed. The first stroke distance and/or the second stroke distance may be changed to tilt the roller shaft 210. The roller shaft 210 may be tilted to increase a contact area between the roller shaft 210 and an object having a curved surface. Due to the increase in the contact area, adhesive force of the tape 160 may be improved. According to an embodiment, the regulator 240 may regulate the pressure of the cylinders 221 and 222 based on the external surface curvature data of the battery cell 100 stored in the memory 250.

A sequence of the pressing operation 310 and the pressure regulating operation 320 may be changed. For example, in FIG. 5, the pressing operation 310 is illustrated as being performed before the pressure regulating operation 320, but this is illustrative. The pressing operation 310 and the pressure regulating operation 320 may be performed simultaneously, or the pressure regulating operation 320 may be performed before the pressing operation 310.

The contents described above are merely examples of applying principles of the present disclosure, and other configurations may be further included without departing from the scope of the present disclosure.

Although the embodiments of the present disclosure have been described above, the scope of the present disclosure is not limited thereto, and it will be apparent to those skilled in the art that various modifications and variations are possible within a scope that does not depart from the technical idea of the present disclosure as described in the claims. For example, the present disclosure may be implemented by deleting some of the components in the embodiments described above, and respective embodiments may be implemented in combination with each other.

According to an embodiment of the present disclosure, adhesive strength of a tape to an object having a curved surface may be improved.

Only specific examples of implementations of certain embodiments may be described. Variations, improvements and enhancements of the disclosed embodiments and other embodiments may be made based on the disclosure of this patent document.

What is claimed is:

1. A tape attachment device comprising:
a roller shaft including a first end portion and a second end portion opposite to the first end portion; and
a pressing member including a first cylinder connected to the first end portion, and a second cylinder connected to the second end portion and configured to operate independently of the first cylinder,
wherein the roller shaft is configured to tilt based on movement of the pressing member.

2. The tape attachment device of claim 1, further a guide member including a first guide member comprising rotatably connecting the first end portion to the first cylinder, and a second guide member rotatably connecting the second end portion to the second cylinder.

3. The tape attachment device of claim 2, wherein the first guide member includes a first bearing support coupled to the first cylinder, and a first bearing connected to the first end portion and rotatably coupled to the first bearing support, and
the second guide member includes a second bearing support coupled to the second cylinder, and a second bearing connected to the second end portion and rotatably coupled to the second bearing support.

4. The tape attachment device of claim 1, further comprising:
a memory configured to store external surface curvature data; and
a regulator configured to regulate pressure of at least one of the first cylinder or the second cylinder, based on the external surface curvature data.

5. The tape attachment device of claim 4, the regulator includes a first regulator configured to regulate first pressure of the first cylinder, and a second regulator configured to regulate second pressure of the second cylinder.

6. The tape attachment device of claim 5, wherein a first stroke distance of the first cylinder is configured to be changed based on the first pressure, and a second stroke distance of the second cylinder is configured to be changed based on the second pressure, and
a slope of the roller shaft is configured to be changed based on the first stroke distance and the second stroke distance.

7. The tape attachment device of claim 1, wherein the roller shaft is configured to provide external force to a tape, and includes an external circumferential surface located between the first end portion and the second end portion.

8. The tape attachment device of claim 1, wherein the first cylinder and the second cylinder include at least one of a pneumatic cylinder, a hydraulic cylinder, or an actuator, respectively.

9. The tape attachment device of claim 1, wherein the second cylinder is disposed parallel to the first cylinder.

10. The tape attachment device of claim 1, further comprising:
a memory configured to store a limit pressure value; and
a pressure sensor disposed on the roller shaft,
wherein output of the pressing member is configured to be changed based on a pressure value sensed by the pressure sensor and the limit pressure value.

11. A tape attachment method comprising:
a pressing operation of pressing a tape using a roller shaft; and
a pressure regulating operation of regulating at least one of pressure of a first cylinder connected to a first end portion of the roller shaft, or pressure of a second cylinder connected to a second end portion of the roller shaft,
wherein the roller shaft is configured to tilt based on the pressure regulating operation.
